(19) United States
(12) Patent Application Publication
(10) Pub. No.: US 2023/0407831 A1
(43) Pub. Date: Dec. 21, 2023

(54) IGNITION COIL

(71) Applicant: DIAMOND&ZEBRA ELECTRIC MFG. CO., LTD., Osaka (JP)

(72) Inventor: Atsushi SHINOHARA, Osaka (JP)

(73) Assignee: DIAMOND&ZEBRA ELECTRIC MFG. CO., LTD., Osaka (JP)

(21) Appl. No.: 18/199,076

(22) Filed: May 18, 2023

(30) Foreign Application Priority Data
Jun. 17, 2022 (JP) 2022-098377

(51) Int. Cl. F02P 3/02

(52) U.S. Cl. CPC F02P 3/02

(57) ABSTRACT

A boot of an ignition coil 2 includes: a main portion 18; a distal end portion 22; a seal portion 24 located between the main portion 18 and the distal end portion 22 and having a larger outer diameter than the main portion 18; and an air passage 28. When the ignition coil 2 is mounted on an internal combustion engine 20, the main portion 18 is exposed to an external environment, the distal end portion 22 is inserted in a plug hole 34 of the internal combustion engine 20, the seal portion 24 separates the external environment and the plug hole 34 from each other, and the air passage 28 connects the external environment and the plug hole 34 to each other. A first opening 44 of the air passage 28 is located in an outer circumferential surface of the main portion 18.

### CROSS-REFERENCE TO RELATED APPLICATION

This application claims priority on and the benefit of Patent Application No. 2022-098377 filed in JAPAN on Jun. 17, 2022. The entire disclosures of this Japanese Patent Application are hereby incorporated by reference.

### BACKGROUND OF THE INVENTION

### Field of the Invention

The present specification discloses an ignition coil for an internal combustion engine.

### Description of the Related Art

An ignition coil for an internal combustion engine includes: a coil assembly including a coil that generates a high voltage; and a boot extending downward from the coil assembly. With the ignition coil mounted on the internal combustion engine, a lower portion of the boot is inserted in a plug hole of the internal combustion engine. The boot may be in a bent-shape to meet the requirement that the internal combustion engine and peripheral devices be arranged as compactly as possible.

During the use of the internal combustion engine, the interior of the plug hole becomes hot. Air inside the plug hole expands, and the pressure inside the plug hole increases. Japanese Laid-Open Patent Application Publication No. 2012-193670 discloses an ignition coil device including an air vent for discharging air out of a plug hole.

An internal combustion engine such as an engine mounted on a vehicle might be exposed to rain water or cleaning water. In case that such water enters a plug hole of the engine through an air vent (air passage) connecting the external environment and the interior of the plug hole, the water can hinder proper combustion. There is a demand for an ignition coil that reduces water entry into a plug hole.

The present inventors aim to provide an ignition coil including an air passage that water is less likely to enter.

### SUMMARY OF THE INVENTION

An ignition coil for an internal combustion engine according to one embodiment includes: a coil assembly including a primary coil and a secondary coil; and a boot shaped as a tube extending downward from the coil assembly. The boot includes: a main portion; a distal end portion; a seal portion located between the main portion and the distal end portion and having a larger outer diameter than the main portion; and an air passage. When the ignition coil is mounted on the internal combustion engine, the main portion is exposed to an external environment, the distal end portion is inserted in a plug hole of the internal combustion engine, the seal portion separates the external environment and the plug hole from each other, and the air passage connects the external environment and the plug hole to each other. A first opening of the air passage is located in an outer circumferential surface of the main portion.

With the ignition coil of this embodiment mounted on the internal combustion engine, the boot includes the air passage connecting the external environment and the plug hole of the internal combustion engine to each other. The first opening of the air passage is located in the outer circumferential surface of the main portion of the boot. Water is likely to be retained on the seal portion having a larger outer diameter than the main portion. Since the first opening is located in the outer circumferential surface of the main portion located above the seal portion, water entry into the air passage is effectively reduced. The ignition coil is resistant to water entry into the air passage.

### BRIEF DESCRIPTION OF THE DRAWINGS

FIG. 1 is a perspective view showing an ignition coil according to one embodiment.

FIG. 2 is a partial cross-sectional view showing the ignition coil of FIG. 1 as mounted on the internal combustion engine.

FIG. 3 is an enlarged cross-sectional view of a part of FIG. 2.

FIG. 4 is an enlarged view of a part of the ignition coil of FIG. 1.

FIG. 5A is an enlarged view of a part of an ignition coil according to another embodiment, and FIG. 5B is an enlarged view of an ignition coil according to yet another embodiment.

FIG. 6 is a perspective view showing an ignition coil according to yet another embodiment.

### DESCRIPTION OF THE PREFERRED EMBODIMENTS

The following will describe in detail preferred embodiments with appropriate reference to the drawings.

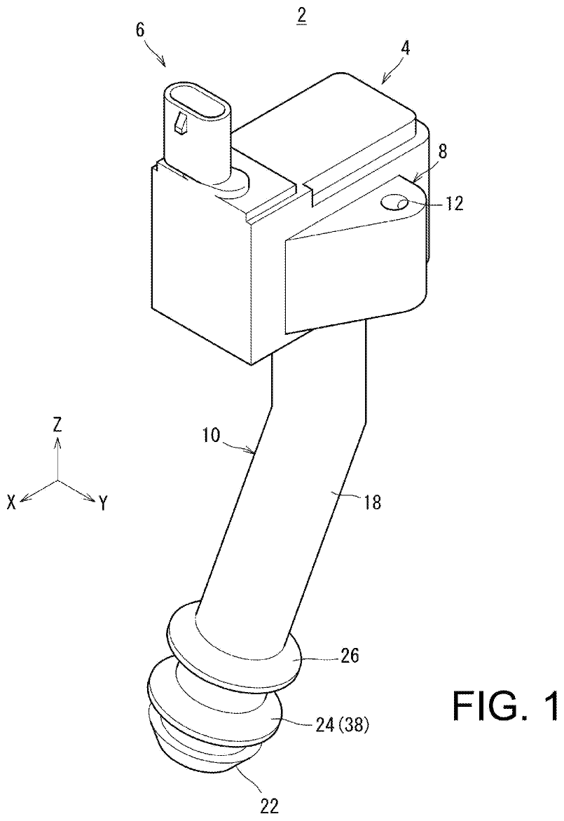

FIG. 1 is a perspective view showing an ignition coil 2 according to one embodiment. In FIG. 1, the arrow X represents the forward direction with respect to the ignition coil 2. The opposite direction is the backward direction. The arrow Y represents the rightward direction with respect to the ignition coil 2. The opposite direction is the leftward direction. The arrow Z represents the upward direction with respect to the ignition coil 2. The opposite direction is the downward direction. The ignition coil 2 is for use in an internal combustion engine. Typical examples of the internal combustion engine include engines for vehicles such as automobiles. The ignition coil 2 includes a coil assembly 4, a connector portion 6, a flange portion 8, and a boot 10. The ignition coil 2 further includes an output portion, although the output portion is hidden by the boot in FIG. 1.

The coil assembly 4 includes a primary coil, a secondary coil, and an iron core which are not shown and further includes a case enclosing the coils and the iron core. The primary coil is formed by winding a wire on the iron core, and the secondary coil is formed by winding a wire around the primary coil. The number of wire turns of the secondary coil is much larger than the number of wire turns of the primary coil. Thus, a change in the current flowing through the primary coil induces a high voltage in the secondary coil.

The connector portion 6 is located at the front of the top surface of the coil assembly 4. In this embodiment, the connector portion 6 extends upward. Although not shown, the connector portion 6 includes an external terminal to which an external signal is input. The operation of the ignition coil 2 is controlled by the signal input to the external terminal.

The flange portion 8 projects from the right surface of the coil assembly 4. The flange portion 8 is integral with the case of the coil assembly 4. The flange portion 8 is provided with an attachment hole 12 extending through the flange portion 8 in the vertical direction. With the ignition coil 2 mounted on an internal combustion engine, a bolt is inserted in the attachment hole 12 of the flange portion 8. The bolt fixes the ignition coil 2 to the internal combustion engine.

In this embodiment, the connector portion 6 is located on the top surface of the coil assembly 4, and the flange portion 8 is located on the right surface of the coil assembly 4. The relationship between the locations of the connector portion 6 and the flange portion 8 is not limited to that in this embodiment. For example, the connector portion 6 and the flange portion 8 may be located along opposite surfaces of the coil assembly 4.

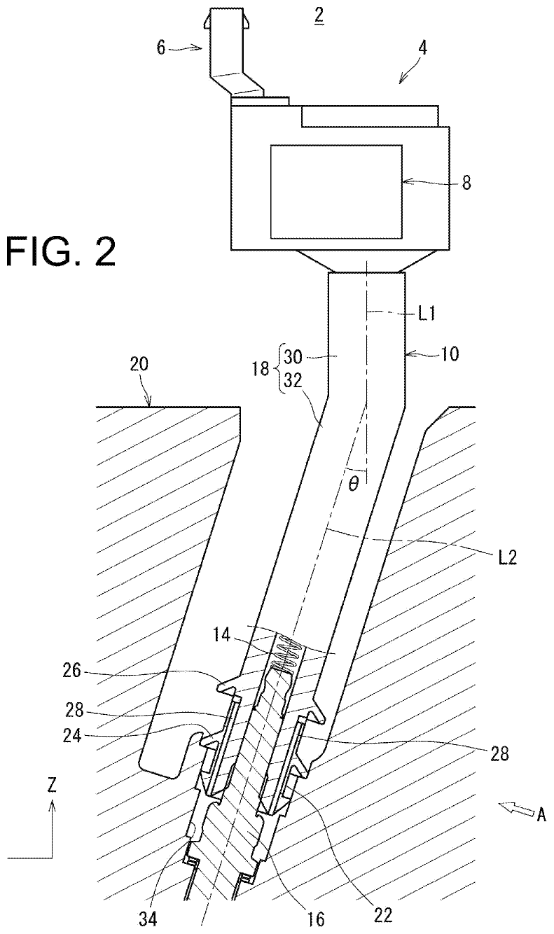

Although hidden by the boot 10, the output portion is located below the coil assembly 4. The output portion is shaped as a tube extending downward from the coil assembly 4. The output portion includes a resistor to which the output of the secondary coil is connected. The high voltage induced in the secondary coil is supplied to an ignition plug 16 (see FIG. 2) mounted on the internal combustion engine through the resistor and a spring 14 (see FIG. 2) located inside the boot 10.

The boot 10 is located below the coil assembly 4. The boot 10 extends downward from the coil assembly 4. The boot 10 covers the circumference of the output portion and extends further downward beyond the output portion. As shown in FIG. 1, the boot 10 has a bend. The boot 10 is a bent boot 10. A preferred example of the material of the boot 10 is silicone rubber.

FIG. 2 is a partial cross-sectional view showing the ignition coil 2 as mounted on an internal combustion engine 20. In this figure, the ignition plug 16 and the spring 14 are also shown. The boot 10 includes a hole extending from the top to bottom of the boot 10. The boot is tubular. As shown in FIG. 2, the spring 14 is located inside the boot 10. The spring 14 electrically connects the resistor of the output portion to the ignition plug 16. The boot 10 includes a main portion 18, a distal end portion 22, a seal portion 24, a guard 26, and an air passage 28.

The main portion 18 extends downward from the coil assembly 4. With the ignition coil 2 mounted on the internal combustion engine 20, the main portion 18 is exposed to the external environment. As shown in FIG. 2, the main portion 18 is in a bent shape. The main portion 18 bent in this manner includes a first portion 30 extending downward from the coil assembly 4 and a second portion 32 continuous with the first portion 30. The second portion 32 is inclined with respect to the vertical direction.

In FIG. 2, the dashed-dotted line L1 represents the centerline of the first portion 30, and the dashed-dotted line L2 represents the centerline of the second portion 32. The centerline L2 coincides with the centerlines of the distal end portion 22 and the seal portion 24. That is, both the distal end portion 22 and the seal portion 24 are inclined with respect to the vertical direction, and the angle of inclination of the distal end portion 22 and the seal portion 24 with respect to the vertical direction is the same as the angle of inclination of the second portion 32 with respect to the vertical direction. In FIG. 2, the symbol 0 represents the angle formed by the centerline L2 with the vertical direction.

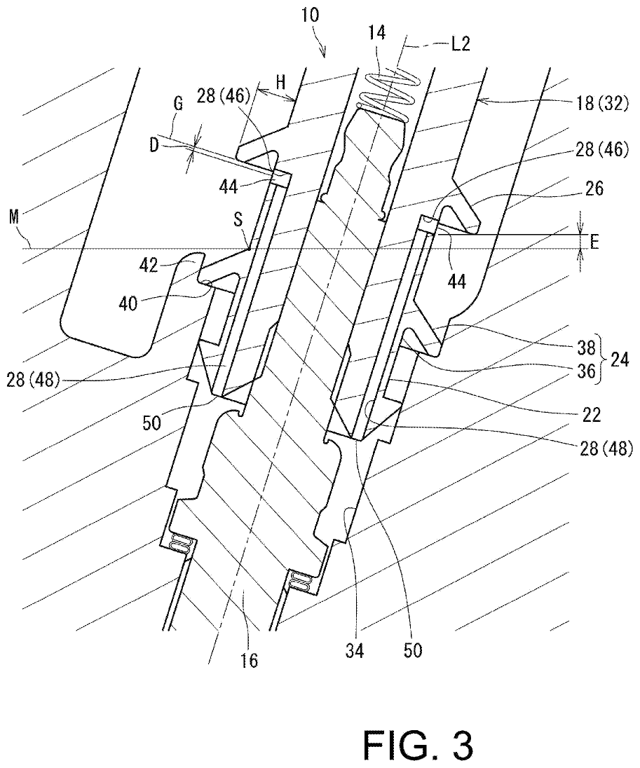

FIG. 3 is an enlarged view of a part of FIG. 2. The distal end portion 22 forms a bottom end portion of the boot 10. The distal end portion 22 is tubular. As shown in FIG. 3, with the ignition coil 2 mounted on the internal combustion engine 20, the distal end portion 22 is inserted in a plug hole 34 of the internal combustion engine 20. The ignition plug 16 is inserted through the bottom opening of the distal end portion 22.

The seal portion 24 is located between the main portion 18 and the distal end portion 22. As shown in FIG. 3, the seal portion 24 includes a tubular body portion 36 and a projecting portion 38 projecting from the body portion 36. As shown in FIG. 1, the projecting portion 38 extends in the circumferential direction of the body portion 36. The projecting portion 38 is ring-shaped. As shown in FIG. 3, the projecting portion 38 is inclined with respect to the centerline L2 in a cross-section perpendicular to the circumferential direction. The projecting portion 38 is inclined to extend downward away from the centerline L2. The outer diameter of the projecting portion 38 (i.e., the outer diameter of the seal portion 24) is larger than the outer diameter of the main portion 18. The outer diameter of the projecting portion 38 is larger than the inner diameter of the opening of the plug hole 34.

As shown in FIG. 3, the internal combustion engine 20 includes an attachment surface 40 where the plug hole 34 is located and a side wall 42 surrounding the opening of the plug hole 34. The distal end of the projecting portion 38 is pressed against the corners between the attachment surface 40 and the side wall 42. Thus, the plug hole 34 is separated from the external environment.

The guard 26 projects from the outer circumferential surface of the main portion 18. The guard 26 projects from the outer circumferential surface of the second portion 32. In this embodiment, as shown in FIG. 1, the guard 26 extends in the circumferential direction of the second portion 32. The guard 26 is ring-shaped. As shown in FIG. 3, the guard 26 is inclined with respect to the centerline L2 in a cross-section perpendicular to the circumferential direction. The guard 26 is inclined to extend downward away from the centerline L2.

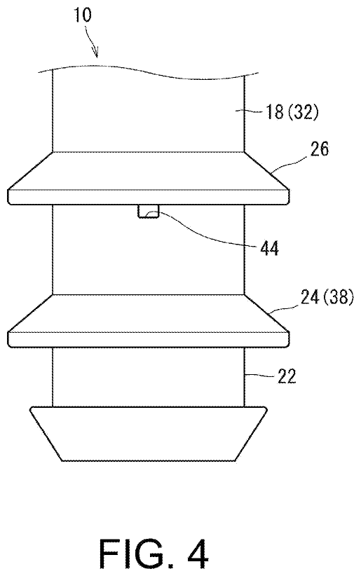

FIG. 4 shows the guard 26, the seal portion 24, and their vicinity as viewed in the direction of the arrow A of FIG. 2. The direction A is perpendicular to the centerline L2. As shown in FIGS. 3 and 4, a first opening 44 of the air passage 28 is located in the outer circumferential surface of the second portion 32. The first opening 44 is located between the guard 26 and the seal portion 24. In this embodiment, as shown in FIG. 3, the air passage 28 includes an outlet portion 46 and a through-passage portion 48. The outlet portion 46 extends from the first opening 44 toward the centerline L2. The through-passage portion 48 extends from an end of the outlet portion 46 to the bottom surface of the distal end portion 22 along the centerline L2. A second opening 50 of the air passage 28 is located in the bottom surface of the distal end portion 22. The opening 50 opens to the plug hole 34. That is, the air passage 28 connects the external environment and the plug hole 34 to each other. In this embodiment, as shown in FIG. 3, there are two air passages 28. The number of the air passages 28 is not limited to two. There may be only one air passage 28. There may be three or more air passages 28.

The following will describe advantageous effects of the present embodiment.

With the ignition coil 2 of this embodiment mounted on the internal combustion engine 20, the boot 10 includes the air passages 28 connecting the external environment and the plug hole 34 of the internal combustion engine 20 to each other. The first openings 44 of the air passages 28 are located in the outer circumferential surface of the main portion 18 of the boot Water is likely to be retained on the seal portion 24 having a larger outer diameter than the main portion 18. Since the first openings 44 are located in the outer circumferential surface of the main portion 18 located above the seal portion 24, water entry into the air passages 28 is effectively reduced. The ignition coil 2 is resistant to water entry into the air passages 28.

In this embodiment, the guard 26 projecting from the main portion 18 is located on the outer circumferential surface of the main portion 18. The first openings 44 are located between the guard 26 and the seal portion 24. The guard 26 effectively prevents water entry into the air passages 28. The ignition coil 2 is resistant to water entry into the air passages 28.

The first openings 44 are preferably located in the second portion 32 of the main portion 18. In this case, the air passages 28 can be shortened since the second portion 32 is closer to the distal end portion 22 than the first portion 30. This makes the formation of the air passages 28 easier. Since the boot 10 has no bend in the second portion 32 or distal end portion 22, the through-passage portions 48 of the air passages 28 can be free of any bends. This makes the formation of the air passages 28 easier and contributes to effective heat release through the air passages 28.

In FIG. 3, the symbol S represents the top end of the inclined seal portion 24. The symbol M is an imaginary line extending in the horizontal direction and passing through the top end S. As shown in FIG. 3, both of the two first openings 44 are located above the imaginary line M. It is preferable that the first openings 44 be located above the imaginary line M as in this case. That is, the first openings 44 are preferably located above the top end S of the inclined seal portion 24. Water coming from outside is likely to be retained on the top surface of the projecting portion 38 of the seal portion 24. The level of the retained water could reach the vicinity of the imaginary line M. When the first openings 44 are located above the top end S of the seal portion 24, water entry into the air passages 28 is effectively reduced.

In FIG. 3, the double-headed arrow E represents the distance between the bottom end of the lower one of the first openings 44 and the imaginary line M in the vertical direction. The distance E is preferably 2 mm or more. When the distance E is 2 mm more, water entry into the air passages 28 is more effectively reduced. From this viewpoint, the distance E is more preferably 3 mm or more.

In FIG. 3, the straight line G is an imaginary line perpendicular to the centerline L2 and passing through the distal end of the guard 26. Preferably, at least a part of each first opening 44 is located below the imaginary line G. When at least a part of each first opening 44 is located below the imaginary line G, the guard 26 is less likely to act as an obstacle during formation of the outlet portions 46 of the air passages 28. In the ignition coil 2, the air passages 28 can easily be formed. From this viewpoint, the entire first openings 44 are more preferably located below the imaginary line G.

In FIG. 3, the double-headed arrow D represents the distance between the center of each first opening 44 and the straight line G as measured in the direction in which the centerline L2 extends. The double-headed arrow H represents the height of the guard 26 as measured in the direction in which the imaginary line G extends. The distance D is preferably equal to or smaller than the height H. When the distance D is equal to or smaller than the height H, the guard 26 more effectively prevents water entry into the air passages 28. From this viewpoint, the distance D is more preferably 80% or less, even more preferably 50% or less, still even more preferably 30% or less, of the height H.

In this embodiment, the guard 26 is shaped as a ring extending in the circumferential direction of the second portion 32. Being ring-shaped, the guard 26 can prevent water entry into the air passages 28 when water comes from various directions.

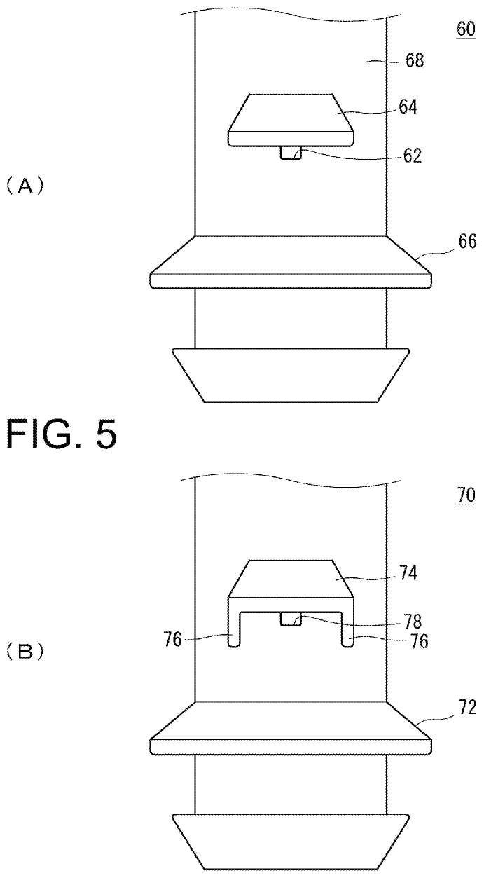

FIG. 5A shows a part of an ignition coil 60 according to another embodiment. This figure shows the ignition coil 60 as viewed in the direction A of FIG. 2. In this figure, a seal portion 66, a guard 64, and their vicinity are shown. As shown in the figure, a first opening 62 is located below the guard 64. In this embodiment, the guard 64 does not extend over the entire circumference of a second portion 68. The guard 64 extends only over a segment of the circumference of the second portion 68. The guard 64 is not ring-shaped but arc-shaped. In the circumferential direction of the second portion 68, the center of the guard 64 is at the same location as the center of the first opening 62. The ignition coil 60 is the same as the ignition coil 2 of FIG. 1, except for the shape of the guard 64.

In the ignition coil 60, the guard 64 is located above the first opening 62. The guard 64 reduces water entry into the air passage. Since the guard 64 is arc-shaped, the guard 64 can be lighter and less expensive in material cost than when the guard 64 is ring-shaped.

FIG. 5B shows a part of an ignition coil 70 according to yet another embodiment. This figure shows the ignition coil 70 as viewed in the direction A of FIG. 2. In this figure, a seal portion 72, a guard 74, and their vicinity are shown. The guard 74 of the ignition coil 70 differs from the guard 64 of FIG. 5A in that the guard 74 further includes side wall portions 76 at its circumferential ends. The ignition coil 70 is the same as the ignition coil 2 of FIG. 1, except for the shape of the guard 74.

In the ignition coil 70, since the guard 74 includes the side wall portions 76, the guard 74 can prevent water entry into the air passage not only when water comes toward the first opening 78 from above but also when water comes toward the first opening 78 from the side. In the ignition coil 70, water entry into the air passage is effectively reduced.

The guard is not limited to being shaped as described above. For example, the guard may be shaped as a ring surrounding the first opening. The guard may be in a shape different from those mentioned above. The guard may be in any shape as long as the guard can prevent water from entering the first opening from above.

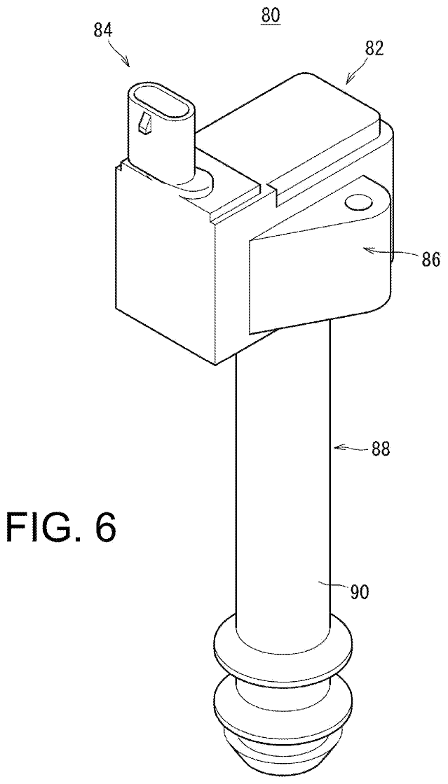

FIG. 6 shows an ignition coil 80 according to yet another embodiment. As shown in FIG. 6, the ignition coil 80 includes a coil assembly 82, a connector portion 84, a flange portion 86, and a boot 88. The ignition coil further includes an output portion, although the opening portion is hidden by the boot 88 in FIG. 6. In the ignition coil 80, the coil assembly 82, the connector portion 84, the flange portion 86, and the output portion are the same as the corresponding elements of the ignition coil 2 of FIG. 1.

The boot 88 is located below the coil assembly 82. The boot 88 extends downward from the coil assembly 82. The boot 88 covers the circumference of the output portion and extends further downward beyond the output portion. A preferred example of the material of the boot 88 is silicone rubber.

In this embodiment, the boot 88 is bendable. In other words, the boot 88 is elastic enough to be bendable. As shown in FIG. 6, the boot 88 extends straight when not subjected to any external force. The boot 88 has no bend. The boot 88 is a straight boot 88. When a force is applied to the boot 88 in a direction in which the boot 88 is bendable, a main portion 90 of the boot 88 is bent at a given point. In the bent state, the boot 88 includes a first portion and a second portion just as does the boot of FIG. 2. The boot 88 in this state can be used as a bent boot 88. When bent in such a manner that the angle between the centerline of the second portion and the vertical direction is equal to the angle θ of FIG. 2, the boot 88 has the same structure as the boot 10 of FIGS. 1 to 4. The boot 88 is the same as the boot 10 of the ignition coil 2 of FIG. 1, except for being bendable.

In the ignition coil 80, the boot 88 is formed in a straight shape. The mold for forming the boot 88 is simple in structure. This contributes to reduction in manufacturing cost of the ignition coil 80.

In the ignition coil 80, the boot 88 can take either a straight shape or a bent shape. The angle of inclination of the second portion can be adjusted as appropriate. Thus, the ignition coil 80 is attachable to various kinds of internal combustion engines. This contributes to reduction in cost of the ignition coil 80.

According to each of the above embodiments, as described above, the ignition coil is resistant to water entry into the air passage. This demonstrates the superiority of the above embodiments.

[Disclosed Items]

The following items are disclosures of preferred embodiments.

[Item 1]

An ignition coil for an internal combustion engine, the ignition coil including:
a coil assembly including a primary coil and a secondary coil; and
a boot shaped as a tube extending downward from
the coil assembly, wherein
   the boot includes
   a main portion,
   a distal end portion,
   a seal portion located between the main portion and the distal end portion and having a larger outer diameter than the main portion, and
   an air passage, wherein
when the ignition coil is mounted on the internal combustion engine, the main portion is exposed to an external environment, the distal end portion is inserted in a plug hole of the internal combustion engine, the seal portion separates the external environment and the plug hole from each other, and the air passage connects the external environment and the plug hole to each other, and
a first opening of the air passage is located in an outer circumferential surface of the main portion.

[Item 2]

The ignition coil according to item 1, wherein a second opening of the air passage is located in a bottom surface of the distal end portion.

[Item 3]

The ignition coil according to item 1 or 2, wherein
the boot further includes a guard projecting from the outer circumferential surface of the main portion, and
the first opening is located between the guard and the seal portion.

[Item 4]

The ignition coil according to any one of items 1 to 3, wherein
the main portion is in a bent shape and includes a first portion extending from the coil assembly and a second portion continuous with the first portion, inclined with respect to a vertical direction, and extending to the seal portion, and
the first opening is located in the second portion.

[Item 5]

The ignition coil according to item 4, wherein
the seal portion is inclined with respect to the vertical direction due to inclination of the second portion, and
the first opening is located above a top end of the inclined seal portion.

[Item 6]

The ignition coil according to any one of items 1 to 3, wherein the main portion is bendable and can take either a straight shape or a bent shape.

The ignition coil described above is usable in various kinds of internal combustion engines.

The foregoing description is given for illustrative purposes, and various modifications can be made without departing from the principles of the present invention.

What is claimed is:

1. An ignition coil for an internal combustion engine, the ignition coil comprising:
a coil assembly including a primary coil and a secondary coil; and
a boot shaped as a tube extending downward from the coil assembly, wherein
the boot includes
a main portion,
a distal end portion,
a seal portion located between the main portion and the distal end portion and having a larger outer diameter than the main portion, and
an air passage, wherein
when the ignition coil is mounted on the internal combustion engine, the main portion is exposed to an external environment, the distal end portion is inserted in a plug hole of the internal combustion engine, the seal portion separates the external environment and the plug hole from each other, and the air passage connects the external environment and the plug hole to each other, and
a first opening of the air passage is located in an outer circumferential surface of the main portion.

2. The ignition coil according to claim 1, wherein a second opening of the air passage is located in a bottom surface of the distal end portion.

3. The ignition coil according to claim 1, wherein
the boot further includes a guard projecting from the outer circumferential surface of the main portion, and
the first opening is located between the guard and the seal portion.

4. The ignition coil according to claim 1, wherein
the main portion is in a bent shape and includes a first portion extending from the coil assembly and a second portion continuous with the first portion, inclined with respect to a vertical direction, and extending to the seal portion, and
the first opening is located in the second portion.

5. The ignition coil according to claim 4, wherein
the seal portion is inclined with respect to the vertical direction due to inclination of the second portion, and
the first opening is located above a top end of the inclined seal portion.

6. The ignition coil according to claim 1, wherein the main portion is bendable and can take either a straight shape or a bent shape.
